(19) United States
(12) Patent Application Publication
(10) Pub. No.: US 2026/0139962 A1
(43) Pub. Date: May 21, 2026

(54) METHOD FOR MATCHING ENVIRONMENTAL SENSOR SCANS

(71) Applicant: Robert Bosch GmbH, Stuttgart (DE)

(72) Inventors: Erik Einhorn, Sarstedt (DE); Hans-Georg Raumer, Hildesheim (DE); Pierre Lothe, Hildesheim (DE); Thorben Funke, Sarstedt (DE)

(21) Appl. No.: 19/382,647

(22) Filed: Nov. 7, 2025

(30) Foreign Application Priority Data
Nov. 18, 2024 (DE) 10 2024 211 032.9

(51) Int. Cl. G01C 21/00

(52) U.S. Cl. CPC G01C 21/3833

(57) ABSTRACT

A method for matching environmental sensor scans that are designed to scan an environment and provide scans of the environment. The method includes the following method step. At least one matching transformation between a scan of an environmental sensor and a reference scan of an environmental sensor serving as a reference sensor is ascertained. When ascertaining the transformation, at least one further scan of the environmental sensor and/or of a further environmental sensor is taken into account.

### CROSS REFERENCE

The present application claims the benefit under 35 U.S.C. § 119 of Germany Patent Application No. DE 10 2024 211 032.9 filed on Nov. 18, 2024, which is expressly incorporated herein by reference in its entirety.

### FIELD

The present invention relates to a method for matching environmental sensor scans.

### BACKGROUND INFORMATION

Certain so-called scan matching or map alignment methods are described in the related art. The goal of scan matching or map alignment is to determine a matching transformation between input data or environmental sensor scans. This transformation constitutes a key step in creating a consolidated map from multiple, partially overlapping scans and/or from representations derived from the scans.

In some conventional approaches, the determination of the matching transformation typically takes place in three steps: In a first step, descriptors of two scans are generated. In a second step, feature matching is performed in which the descriptors of the two scans are assigned to one another. In a third step, the matching transformation between the two scans is determined on the basis of this assignment.

### SUMMARY

An object of the present invention is to provide an improved method for matching environmental sensor scans. This object may be achieved by a method for matching environmental sensor scans having certain features of the present invention. Advantageous developments of the present invention are disclosed herein.

According to an example embodiment of the present invention, a method for matching environmental sensor scans that are designed to scan an environment and provide scans of the environment comprises the following method step. At least one matching transformation between a scan of an environmental sensor and a reference scan of an environmental sensor serving as a reference sensor is ascertained. When ascertaining the transformation, at least one further scan of the environmental sensor and/or of a further environmental sensor is taken into account.

The method can also be referred to as a scan matching method or map matching method. The environmental sensors are designed to scan an environment and provide sensor data in the form of scans of the environment, which contain information about objects in the environment, such as information about the positions of objects in the environment. The method is based on the concept of ascertaining a matching transformation between scans of different environmental sensors. Alternatively or additionally, the matching transformation between scans of the environment of the same environmental sensor that are recorded at different times can be ascertained. Such a transformation transforms a selected scan into a reference scan or matches the selected scan with the reference scan and typically includes a rotation and/or a translation.

The environmental sensors can, for example, be part of a motor vehicle, in particular an autonomous motor vehicle. In this case, the environmental sensors are designed to detect or scan the environment of the motor vehicle. The environmental sensors can alternatively or additionally be arranged on the vehicle infrastructure, i.e., they are not part of a motor vehicle, but are arranged, for example, in the region of a routing. The present method can thus be used, for example, in the context of creating digital maps for autonomous driving. Alternatively, the environmental sensors can be designed to scan an environment of a robot device to detect obstacles. The method can therefore also be used, for example, in the context of creating a map that is used to plan a robot movement. The environmental sensors are thus generally designed to scan an environment of a device, in particular a device to be navigated and/or a device that is designed to perform movements.

The method can, for example, use sensor data or scans of a camera, a radar detection and ranging (radar) sensor and a light detection and ranging (lidar) sensor. Alternatively or additionally, scans of other environmental sensors can also be used. For example, scans of ultrasonic sensors and/or thermal cameras can be used.

According to an example embodiment of the present invention, the scans can be provided and used, for example, in the form of point clouds. It may be necessary to convert the sensor data into point clouds. A point cloud is generally a set of points in a vector space that has an ordered or disordered structure referred to as a cloud. Since a point cloud is based on a scan of an environment, the point cloud contains information about objects in the environment. For example, the environment of a motor vehicle can be scanned using a lidar sensor and the sensor data can be provided as point clouds. The point cloud of a lidar scan includes points where a laser beam was reflected from objects.

At least three scans are used to ascertain the at least one transformation. The transformation matches a selected scan of an environmental sensor with the reference scan of the reference sensor. However, not only the selected or relevant scan and the reference scan are used to ascertain the transformation. Instead, at least one further scan of the environmental sensor and/or of the further environmental sensor is taken into account when ascertaining the transformation. Since at least three scans are used, the method can also be referred to as a multisample scan matching method. If the matching transformation between scans of the environment of the same environmental sensor is ascertained, the at least one further scan is a scan that was recorded, for example, in the context of a motor vehicle passing by again, i.e., the further scan of the environment was recorded when the motor vehicle passed through the environment again.

In contrast to conventional methods, more than two scans of an environment are used to ascertain the matching transformation. In other words, the presence of more than two scans of the same location or environment is utilized when determining the matching transformations in scan matching. Advantageously, the transformation is more precise. This allows a more accurate digital map of the environment to be created. This in turn makes it possible for autonomous motor vehicles to be navigated more reliably and safely, for example.

The at least one further scan can be taken into account when ascertaining the at least one transformation, for example, by adapting a translation vector that transforms a position of an object in the environment according to the selected scan into positions with respect to the reference scan on the basis of at least one further translation vector that transforms the position of the relevant object in the environment according to the further scan into positions with respect to the reference scan. For example, the transformation can be chosen such that its translation vector is formed by an average value of the translation vector and the at least one further translation vector. In this case, the translation vector of the transformation is ascertained taking into account the at least one further scan. In addition to a translation vector, the transformation can alternatively or additionally also comprise a rotation that maps the scan to the reference scan, wherein the at least one further scan is taken into account when ascertaining the rotation. This can, for example, also comprise averaging between a rotation and at least one further rotation in order to adapt the rotation that transforms orientations of the objects according to the selected scan into orientations with respect to the reference scan on the basis of the at least one further rotation that transforms orientations of the objects according to the further scan into orientations with respect to the reference scan.

In one example embodiment of the present invention, a plurality of further scans of the environmental sensor and/or further environmental sensors are taken into account when ascertaining the transformation between the scan and the reference scan. In this case, not only one further scan, but a plurality or, in particular, all available further scans of the environment are taken into account when ascertaining the transformation between the scan and the reference scan. When ascertaining the matching transformation, for example, at least one further scan per further environmental sensor can be taken into account. In this case, scans of different environmental sensors are therefore taken into account to ascertain the matching transformation. Alternatively or additionally, a plurality of further scans of the environmental sensor that were recorded at different times can be taken into account, for example further scans that were recorded in the context of a motor vehicle passing by again. In particular in the application area of crowd mapping, there is usually a large number of scans for a location, for example one scan per vehicle and pass-by, which can improve the accuracy of the transformation and thus also the map quality.

In one example embodiment of the present invention, for the at least one further scan, a further transformation between the further scan and the reference scan is ascertained. When ascertaining the further transformation between the further scan and the reference scan, the scan or an additional scan of an additional environmental sensor is taken into account.

In this variant, a total of N−1 transformations to the reference scan can be ascertained for N>2 scans that comprise the reference scan. This is done in a way in which for each transformation ascertainment, information from all scans or point clouds, or at least from some of the scans, is preferably used and not just information from two respective scans between which the matching transformation is to be ascertained. In order to ascertain a transformation between a random scan and the reference scan, information from some of the scans or information from all available scans of the same location or environment is therefore used. This can help to obtain more consistent and robust estimates of the transformations, which can also help to increase map quality.

In one example embodiment of the present invention, the scan and the reference scan comprise information about different regions of an environment that do not overlap. In this embodiment, scan matching between the scan and reference scan can advantageously be performed even though the scan and reference scan comprise information about different regions or surrounding areas in the environment. This is made possible by taking into account the at least one further scan when ascertaining the transformation. To make this possible, the at least one further scan must at least partially include information about regions that overlap with regions of the scan and regions of the reference scan. The more further scans are taken into account when ascertaining the transformation, the more accurately a transformation can be ascertained if the scan and reference scan do not overlap. In contrast, conventional scan matching methods do not allow a transformation between non-overlapping scans to be ascertained.

In one example embodiment of the present invention, ascertaining the at least one transformation comprises the following steps: A descriptor set is generated for the scan, the reference scan and the at least one further scan. The at least one transformation is estimated on the basis of the descriptor sets of the scan and reference scan, wherein the descriptor set of the at least one further scan is taken into account when estimating the transformation between the scan and reference scan.

A descriptor can also be referred to as a feature vector. A descriptor generally comprises properties of a pattern represented as a vector. Different characteristic features form the different dimensions of the descriptor. When generating a descriptor set associated with a scan, only the associated scan is taken into account. Estimating the transformation can also involve assigning descriptors, wherein corresponding descriptors of different sets are assigned to one another.

In one example embodiment of the present invention, the at least one transformation is estimated on the basis of a correspondence matrix between the descriptor set of the scan and the descriptor set of the reference scan. At least one further correspondence matrix between the descriptor set of the at least one further scan and the descriptor set of the reference scan is taken into account when estimating the at least one transformation.

In one example embodiment of the present invention, the at least one transformation is ascertained by a neural network. According to one embodiment, the neural network is fully differentiable. The input data consist of at least three scans of the environment (N>2), of which one scan serves as a reference scan. The neural network is designed to ascertain the at least one transformation on the basis of such input data. If a transformation is ascertained for all pairs of scans of different environmental sensors and reference scan, a total of N−1 transformations are ascertained, since the transformations are always ascertained with respect to the reference scan. When ascertaining each transformation, information from some of the scans or point clouds or, preferably, from all N scans or point clouds can be taken into account.

In one example embodiment of the present invention, the descriptor sets are generated by a first subnet of the neural network and the at least one transformation is estimated by a separate second subnet of the neural network. In one embodiment, for each scan the first subnet has a separate subnetwork for generating a descriptor set. The subnetworks are designed to generate the descriptor sets in parallel.

### BRIEF DESCRIPTION OF THE DRAWING

FIG. 1 shows a method for matching environmental sensor scans according to an example embodiment of the present invention.

### DETAILED DESCRIPTION OF EXAMPLE EMBODIMENTS

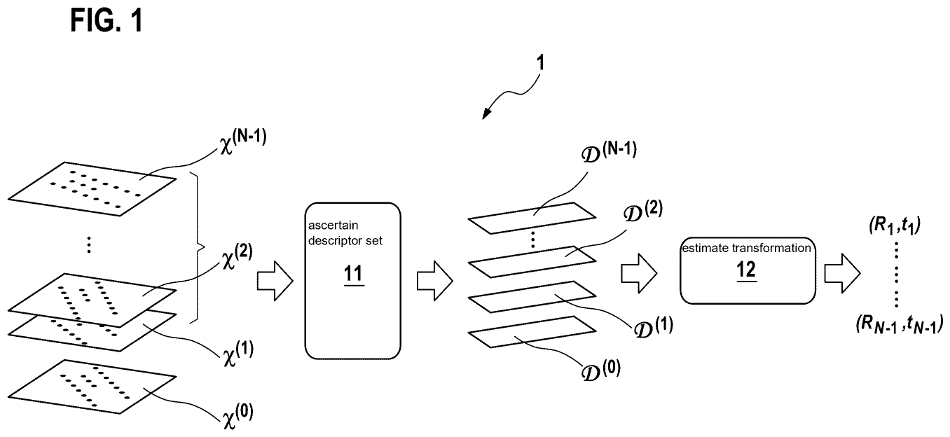

Hereinafter, the method for matching environmental sensor scans is explained in more detail in connection with FIG. 1.

Method 1 is based on the concept of scan matching with more than two scans and treats the underlying problem as a regression problem. The advantage of the method is that the presence of more than two scans of the same location or environment is utilized when determining matching transformations in scan matching in order to ascertain a more precise transformation.

Given are N>2 scans χ⁽⁰⁾, χ⁽¹⁾, . . . , χ^{(N-1)} of a plurality of different environmental sensors for detecting an environment, which are used in the form of point clouds in [symbol] with usually d∈{2,3}:

$${𝒳}^{( 0 )} = \{ {x}_{1}^{( 0 )} , … , {x}_{{M}_{0}}^{( 0 )} \} ,$$

$$⋮$$

$${𝒳}^{( N - 1 )} = \{ {x}_{1}^{( N - 1 )} , … , {x}_{{M}_{N - 1}}^{( N - 1 )} \}$$

Here, the xᵢ^{(j)} are points of the point cloud or scan χ^{(j)} of an environmental sensor Uⱼ, wherein each scan χ^{(j)} has a number of M points. Now at least one matching transformation (R₁, t₁) is to be ascertained, but a total of up to N−1 matching transformations (R₁, t₁, . . . , R_{N-1}, t_{N-1}) each consisting of a rotation Rⱼ∈SO(d) and a translation vector tⱼ can be ascertained, which match each of the point clouds χ⁽¹⁾, . . . , χ^{(N-1)} with a point cloud, which is defined as a reference point cloud χ⁽⁰⁾, of an environmental sensor serving as a reference sensor U₀. It is therefore sufficient if at least a first transformation (R₁, t₁) between a first scan χ⁽¹⁾ and the reference scan χ⁽⁰⁾ is ascertained. However, it is also possible to ascertain for all scans χ⁽¹⁾, . . . , χ^{(N-1)} of all environmental sensors one transformation (R₁, t₁; . . . ; R_{N-1}, t_{N-1}) each between a relevant scan χ⁽¹⁾, . . . , χ^{(N-1)} and the reference scan χ⁽⁰⁾ or only for some of the scans χ⁽¹⁾, . . . , χ^{(N-1)}.

Ascertaining the at least one transformation (R₁, t₁) comprises the following steps. First, in a first step 11, a descriptor set D⁽⁰⁾, D⁽¹⁾, . . . , D^{(N-1)}

$${𝒟}^{( 0 )} = \{ {f}_{1}^{( 0 )} , … , {f}_{{M}_{1}}^{( 0 )} \} ,$$

$$⋮$$

$${𝒟}^{( N - 1 )} = \{ {f}_{1}^{( N - 1 )} , … , {f}_{{M}_{1}}^{( N - 1 )} \}$$

is ascertained for each scan χ^{(j)}, i.e., for the first scan χ⁽¹⁾, the reference scan χ⁽⁰⁾ and for at least one further scan χ⁽²⁾, depending on how many scans should be taken into account when ascertaining the at least one transformation. Each point xᵢ^{(j)} of a point cloud χ^{(j)} is encoded by a descriptor fₖ^{(j)}∈ [symbol] , wherein F is a dimension of the descriptor f, which can also be referred to as a feature vector. Accordingly, a descriptor set D^{(j)} can also be referred to as a set of feature vectors. Ascertaining the descriptor sets D^{(j)} can also be referred to as extracting features or feature vectors.

The descriptor sets D⁽⁰⁾,D⁽¹⁾ of the reference scan χ⁽⁰⁾ and first scan χ⁽¹⁾ are ascertained. In addition, at least the descriptor set D⁽²⁾ of the at least one further scan χ⁽²⁾ is ascertained. When ascertaining the descriptor sets D^{(j)}, N scans or point clouds χ⁽⁰⁾, χ⁽¹⁾, . . . , χ^{(N-1)} are therefore used as input data, and up to N descriptor sets D⁽⁰⁾, D⁽¹⁾, . . . , D^{(N-1)} are ascertained as output data.

The at least one transformation (R₁, t₁) is then estimated on the basis of the descriptor sets D⁽¹⁾, D⁽⁰⁾ of the first scan χ⁽¹⁾ and reference scan χ⁽⁰⁾ in a second step 12. At least one further descriptor set D⁽²⁾ of the at least one further scan χ⁽²⁾ is taken into account when estimating the transformation (R₁, t₁) between the first scan χ⁽¹⁾ and the reference scan χ⁽⁰⁾.

For this purpose, in an exemplary embodiment,

$$( {𝒟}^{( 0 )} , {𝒟}^{( 1 )} ) , … , ( {𝒟}^{( 0 )} , {𝒟}^{( N - 1 )} )$$

a total of up to N−1 stochastic correspondence matrices P⁽ⁿ⁾∈ [symbol] ^{×M0} is ascertained on the basis of pairs of descriptor sets. A stochastic correspondence matrix P⁽ⁿ⁾ has only entries between 0 and 1, as well as row and column sums less than or equal to 1. The closer a matrix value Pᵢⱼ is to 1, the more likely it is that the i-th point of one point cloud corresponds to the j-th point of the other point cloud.

The transformations can now be estimated by a minimization problem on the basis of the correspondence matrices:

$${R}^{( n )} , {t}^{( n )} = arg min {\sum }_{( i , j )} {w}_{ij} {P}_{ij}^{( n )} {‖ {Rx}_{i}^{( n )} + t - {x}_{j}^{( 0 )} ‖}_{2}^{2}$$

The minimization problem given here is explicitly solvable. The wᵢⱼ are weighting factors with which the correspondence matrices P⁽¹⁾, . . . , P^{(N-1)} are weighted. The weighting factors wᵢⱼ can, for example, be selected such that wᵢⱼ=wⱼ, i.e., the wᵢⱼ correspond to a sum of column sums of all j-th columns of the correspondence matrices P⁽¹⁾, . . . , P^{(N-1)}. Alternatively, a function φ can be ascertained on the N−1 column sums of the j-th columns in order to define a weighting on the basis thereof.

When ascertaining the at least one transformation (R₁, t₁), information from all point clouds χ⁽⁰⁾, χ⁽¹⁾, . . . , χ^{(N-1)} can therefore be taken into account. However, in addition to the reference scan χ⁽⁰⁾ of the reference sensor U₀ and the relevant first scan χ⁽¹⁾ of a first environmental sensor U₁, at least one further scan χ⁽²⁾ of a further environmental sensor U₂ is taken into account, but in particular all further scans χ⁽²⁾, . . . , χ^{(N-1)} of all further environmental sensors U₂, . . . , U_{N-1} or only some of the further scans χ⁽²⁾, . . . , χ^{(N-1)} can be taken into account. In other words, when ascertaining the at least one transformation (R₁, t₁) between the first scan χ⁽²⁾ and the reference scan χ⁽⁰⁾, a plurality of scans χ⁽²⁾, . . . , χ^{(N-1)} of different environmental sensors U₂, . . . , U_{N-1} can be taken into account.

Accordingly, one transformation (Rⱼ, tⱼ) each between a relevant scan χ^{(j)} and the reference scan χ⁽⁰⁾ can be ascertained for all scans χ⁽¹⁾, . . . , χ^{(N-1)} of different environmental sensors U₁, . . . , U_{N-1}. A plurality of scans χ⁽¹⁾, . . . , χ^{(N-1)} or at least one further scan χ^{(j)} can be taken into account. I.e., when ascertaining all transformations (Rⱼ, tⱼ), a plurality of scans χ⁽¹⁾, . . . , χ^{(N-1)} can be taken into account.

Taking into account the at least one further scan χ⁽²⁾ when ascertaining the at least one first transformation (R₁, T₁) is done by taking into account the descriptor set D⁽²⁾ of the at least one further scan χ⁽²⁾ when estimating the at least one first transformation (R₁, T₁). Taking into account the descriptor set D⁽²⁾ of the at least one further scan χ⁽²⁾ when estimating the at least one first transformation (R₁, T₁) is done by taking into account not only the correspondence matrix between the descriptor set D⁽¹⁾ of the first scan χ⁽¹⁾ and the descriptor set D⁽⁰⁾ of the reference scan χ⁽⁰⁾, but also the at least one further correspondence matrix between the descriptor set D⁽²⁾ of the at least one further scan χ⁽²⁾ and the descriptor set D⁽⁰⁾ of the reference scan χ⁽⁰⁾ in the context of the minimization problem. Since at least three scans of different environmental sensors are used, the method can also be referred to as a multisample scan matching method.

The at least one transformation may be ascertained on the basis of machine learning. For example, the at least one first transformation can be ascertained by a neural network that can have a first subnet and a subnet, wherein the first subnet is designed to generate the descriptor sets and the second subnet is designed to estimate the at least one transformation. For each scan, the first subnet can have a separate subnetwork for generating a descriptor set. The subnetworks can be designed to generate the descriptor sets in parallel.

Each subnetwork of the first subnet of the neural network is designed as a feature extractor network. The subnetworks can all have an identical architecture, for example a fully convolutional geometric features (FCGF) architecture. The weights of the subnetworks can be identical and shared, but this is not mandatory. An optimal transport layer or a double softmax, for example, can be used as a second subnet or as a differentiable function underlying the second subnet.

The neural network can also be called a multisample scan-matching network. For example, the neural network can be trained as a regression problem using a supervised learning approach. This means that for the training dataset, reference solutions for the transformations (Rₙ*, tₙ*) must be given, which are ascertained on the basis of training scans according to the method described. A cost function (loss) for training can be given, for example, by the following regression error:

$$ℒ = {\sum }_{n = 1}^{N - 1} ( {λ}_{1} {‖ {R}_{n} - {R}_{n}^{*} ‖}_{F}^{2} + {λ}_{2} {‖ {t}_{n} - {t}_{n}^{*} ‖}_{2}^{2} )$$

The weighting between rotation estimation and translation estimation can be modeled with the real weighting factors λ₁, λ₂. If there are fewer than N scans available in a dataset for a specific location or environment, missing scans can also be supplemented using data augmentation.

During training of the neural network, N>2 training scans with associated transformations are used, which have already been ascertained according to the principle of FIG. 1 on the basis of the training scans. The training scans can, for example, be recorded during various journeys within an environment using the environmental sensors. The neural network is trained on the basis of the training scans and the associated matching transformations. The trained neural network is designed to ascertain up to N−1 transformations on the basis of N>2 scans according to the method shown in FIG. 1. The scans or point clouds and the ascertained transformations can be used in the context of creating a digital map or an adaptation.

What is claimed is:

1. A method for matching environmental sensor scans, wherein the environmental sensors are configured to scan an environment and provide scans of the environment, the method comprising:
ascertaining at least one matching transformation between a scan of an environmental sensor and a reference scan of an environmental sensor serving as a reference sensor;
wherein, in addition to the scan and the reference scan, at least one further scan of the environmental sensor and/or of a further environmental sensor is taken into account when ascertaining the transformation.

2. The method according to claim 1, wherein a plurality of further scans of the environmental sensor and/or further environmental sensors are taken into account when ascertaining the transformation between the scan and the reference scan.

3. The method according to claim 1, wherein, for the at least one further scan, a further transformation between the further scan and the reference scan is ascertained, wherein, when ascertaining the further transformation between the further scan and the reference scan, at least the scan or an additional scan of an additional environmental sensor is taken into account.

4. The method according to claim 1, wherein the scan and the reference scan include information about different regions of an environment that do not overlap.

5. The method according to claim 1, wherein the ascertaining of the at least one transformation includes the following steps:
generating a descriptor set for each of the scan, the reference scan, and the at least one further scan,
estimating the at least one transformation based on the descriptor sets of the scan and reference scan,
wherein the descriptor set of the at least one further scan is taken into account when estimating the transformation between the scan and the reference scan.

6. The method according to claim 5, wherein the at least one transformation is estimated based on a correspondence matrix between the descriptor set of the scan and the descriptor set of the reference scan, wherein at least one further correspondence matrix between the descriptor set of the at least one further scan and the descriptor set of the reference scan is taken into account when estimating the at least one transformation.

7. The method according to claim 1, wherein the at least one transformation is ascertained by a neural network.

8. The method according to claim 5, wherein the at least one transformation is ascertained by a neural network, and wherein the descriptor sets are generated by a first subnet of the neural network and the at least one transformation is estimated by a separate second subnet of the neural network.

9. The method according to claim 8, wherein for each, the reference scan, and the at least one further scan, the first subnet has a separate subnetwork for generating the descriptor set, where the subnetworks are configured to generate the descriptor sets in parallel with one another.
